(19) United States
(12) Patent Application Publication
(10) Pub. No.: US 2017/0032527 A1
(43) Pub. Date: Feb. 2, 2017

(54) METHOD AND SYSTEM FOR HEAD DIGITIZATION AND CO-REGISTRATION OF MEDICAL IMAGING DATA

(71) Applicant: IWK HEALTH CENTRE, Halifax (CA)

(72) Inventors: Santosh Vema Krishna MURTHY, Halifax (CA); Matthew Gregoire MACLELLAN, Halifax (CA); Steven D. BEYEA, Halifax (CA); Timothy BARDOUILLE, Halifax (CA)

(21) Appl. No.: 14/815,306

(22) Filed: Jul. 31, 2015

(51) Int. Cl. G06T 7/00; H04N 5/232; G06K 9/62; H04N 5/33; G06T 3/00; G06K 9/00; H04N 9/04; H04N 5/376; G06K 9/46

(52) U.S. Cl. CPC G06T 7/0036; G06T 7/0012; H04N 5/3765; H04N 5/23245; G06K 9/6201; G06K 9/46; G06T 7/0065; G06T 3/00; G06K 9/00281; H04N 9/045; H04N 5/33; G06K 2009/4666; G06T 2207/10088

(57) ABSTRACT

A method for co-registering imaging data from two imaging sources, the method comprising: scanning a subject using a depth sensor to generate depth data; identifying, in the depth data, the locations of first fiducial points and second fiducial points of the scanned subject; receiving first imaging data including the locations of the first fiducial points; generating a first transform function based on the locations of the first fiducial points in both the depth data and the first imaging data; receiving second imaging data including the locations of the second fiducial points; generating a second transform function based on the locations of the second fiducial points in both the depth data and the second imaging data; and mapping the data points in the first imaging data to the data points in the second imaging data based on the first and second transform functions.

### FIELD

The present disclosure relates to capturing and processing medical imaging data.

### BACKGROUND

Medical imaging techniques and devices are used to capture and display visual representations of the interior of a human body. These visual representations may be helpful for diagnosing and treating illnesses. Some well-known forms of medical imaging technology include X-ray and ultrasound.

In X-ray radiography, for example, a beam of electromagnetic radiation in the X-ray spectrum is produced and projected toward the human body. Some of the X-rays are absorbed by the parts of body, depending on the density and composition of those parts, while other X-rays pass through the body and are captured on either film or an electronic sensor. Thus, the captured X-rays reveal variations in the density and composition of the interior of the human body.

A related imaging technology is X-ray computed tomography (also referred to as CT scan, CAT scan, and computerized axial tomography). In a CT scan, multiple X-ray images are taken from various angles relative to the human body subject. A computer assembles these images taken from the different angles and processes them to generate a series of tomographic images, which are virtual slices of the imaged body part, and allows a user to view the three-dimensional structures inside a body.

To the user, the result of the CT scan is more useful than an X-ray because the output of the CT scan is an ordered collection of images comprising three-dimensional or volumetric data, rather than a single two-dimensional image that has flattened three-dimensional structures as in the case of the X-ray image.

The CT scan is one example of a method and system of computer processing known medical imaging data (X-ray images) to generate more useful medical imaging data (tomographic images).

### BRIEF DESCRIPTION OF THE DRAWINGS

Embodiments of the present disclosure will now be described, by way of example only, with reference to the attached Figures.

FIG. 1 is a block diagram showing the input and output of a system according to an embodiment of the present disclosure.

FIG. 2 is a flowchart diagram of a method of co-registering data from two imaging sources, according to an embodiment of the present disclosure.

FIG. 3 is an exemplary image showing overlaid data from MRI and MEG imaging sources as a result of a co-registration method according to an embodiment of the present disclosure.

FIG. 4 is a block diagram showing the input and output of an MRI-MEG co-registration system according to an embodiment of the present disclosure.

FIG. 5 is a flowchart diagram of a method of co-registering data from MRI and MEG imaging sources, according to an embodiment of the present disclosure.

FIG. 6 is a flowchart diagram of a method of generating depth data, according to an embodiment of the present disclosure.

FIG. 7A is a perspective view of data points in depth data generated from a Polhemus™ digitization device.

FIG. 7B is a perspective view of data points in depth data generated from a laser scanning device.

FIG. 7C is a perspective view of data points in depth data generated from a system according to an embodiment of the present disclosure.

FIG. 8 is a perspective view of data points forming a raccoon mask in depth data according to an embodiment of the present disclosure.

### DETAILED DESCRIPTION

The present disclosure is directed to a method and system of co-registering medical imaging data from at least two different imaging technology sources. Co-registration refers to a method of combining source image data in a structured manner in order to produce a dataset of imaging information that contains more useful information than in either source image data alone. In particular, combining imaging data comprises scanning a subject to generate depth data and generating first and second transform functions. The first transform function maps a first imaging data to the depth data and the second transform function maps a second imaging data to the depth data. The first and second transform functions are used to co-register the first imaging data to the second imaging data.

An embodiment of the present disclosure? comprises a method for co-registering imaging data, the method comprising: scanning a subject using a depth sensor to generate depth data; identifying, in the depth data, the locations of first fiducial points and second fiducial points of the scanned subject; receiving first imaging data including the locations of the first fiducial points; generating a first transform function for mapping data in a coordinate system of the first imaging data to data in a coordinate system of the depth data, the first transform function based on the locations of the first fiducial points in both the depth data and the first imaging data; receiving second imaging data including the locations of the second fiducial points; generating a second transform function for mapping a coordinate system of the second imaging data to a coordinate system of the depth data, the second transform function based on the locations of the second fiducial points in both the depth data and the second imaging data; and mapping the data points in the first imaging data to the data points in the second imaging data based on the first and second transform functions.

In a further embodiment, the depth sensor is a multi-sensor device.

In a further embodiment, the multi-sensor device comprises a color camera, an infrared projector, and an infrared camera.

In a further embodiment, generating depth data comprises generating eroded depth data from raw depth data.

In a further embodiment, generating eroded depth data comprises: receiving raw depth data from the depth sensor; generating a mask image and generating a destination image; comparing the value of each pixel in the depth data and eroding a number of pixels around that compared pixel by assigning a one-value in the corresponding mask image pixels and assigning a zero-value in the corresponding destination image pixels; copying values of pixels in the raw depth data for which the corresponding mask image pixel has a value of zero to the destination image; and outputting the destination image as the eroded depth data.

In a further embodiment, the method further comprises: copying values in the raw depth data from a structured depth image array to a pointer array in the destination image; and outputting the eroded depth data by copying the destination pointer array in the destination image to a structured array format.

In a further embodiment, scanning the subject using a multi-sensor device and generating the depth data is performed in real-time at 30 frames per second.

In a further embodiment, scanning the subject comprises rotating the multi-sensor device around the subject during the scanning.

In a further embodiment, the scanned subject is a head and the generated depth data is a raccoon mask.

In a further embodiment, the first imaging data is MEG imaging data and the first fiducial points are HPI coils.

In a further embodiment, the second imaging data is MRI imaging data and the second fiducial points are anatomical landmarks.

In a further embodiment, the anatomical landmarks include at least one of the eyes, the nose, the brow ridge, the nasion, the pre-auricular, and the peri-auricular of a head.

An embodiment of the present disclosure comprises a system for co-registering imaging data, the system comprising: a depth sensor for scanning a subject and generating depth data; and a processor connected to the depth sensor for: identifying, in the depth data, the locations of first fiducial points and second fiducial points of the scanned subject; receiving first imaging data including the locations of the first fiducial points; generating a first transform function for mapping data in a coordinate system of the first imaging data to data in a coordinate system of the depth data, the first transform function based on the locations of the first fiducial points in both the depth data and the first imaging data; receiving second imaging data including the locations of the second fiducial points; generating a second transform function for mapping a coordinate system of the second imaging data to a coordinate system of the depth data, the second transform function based on the locations of the second fiducial points in both the depth data and the second imaging data; and mapping the data points in the first imaging data to the data points in the second imaging data based on the first and second transform functions.

In a further embodiment, the depth sensor is a multi-sensor device.

In a further embodiment, the multi-sensor device comprises a color camera, an infrared projector, and an infrared camera.

In a further embodiment, the processor generates eroded depth data from raw depth data generated from the multi-sensor device.

In a further embodiment, the processor is configured to generate eroded depth data by: receiving raw depth data from the depth sensor; generating a mask image and generating a destination image; comparing the value of each pixel in the depth data and eroding a number of pixels around that compared pixel by assigning a one-value in the corresponding mask image pixels and assigning a zero-value in the corresponding destination image pixels; copying values of pixels in the raw depth data for which the corresponding mask image pixel has a value of zero to the destination image; and outputting the destination image as the eroded depth data.

In a further embodiment, the processor is further configured to generate eroded depth data by: copying values in the raw depth data from a structured depth image array to a pointer array in the destination image; and outputting the eroded depth data by copying the destination pointer array in the destination image to a structured array format.

In a further embodiment, the multi-sensor device scans the subject at 30 frames per second and the processor generates the eroded depth data in real-time at 30 frames per second.

In a further embodiment, the multi-sensor device is rotated around the subject during the scanning.

In a further embodiment, the scanned subject is a head and the generated depth data is a raccoon mask.

In a further embodiment, the first imaging data is MEG imaging data and the first fiducial points are HPI coils.

In a further embodiment, the second imaging data is MRI imaging data and the second fiducial points are anatomical landmarks.

In a further embodiment, the anatomical landmarks include at least one of the eyes, the nose, the brow ridge, the nasion, the pre-auricular, and the peri-auricular of a head.

An embodiment of the present disclosure comprises a method for generating depth data used to co-register imaging data, the method comprising: scanning a subject using a depth sensor to generate raw depth data; generating a mask image and generating a destination image; comparing the value of each pixel in the depth data and eroding a number of pixels around that compared pixel by assigning a one-value in the corresponding mask image pixels and assigning a zero-value in the corresponding destination image pixels; copying values of pixels in the raw depth data for which the corresponding mask image pixel has a value of zero to the destination image; outputting the destination image as the eroded depth data; and identifying, in the eroded depth data, the locations of first fiducial points and second fiducial points of the scanned subject.

An embodiment of the present disclosure comprises a system for generating depth data used to co-register imaging data, the system comprising: a depth sensor for scanning a subject and generating raw depth data; and a processor connected to the depth sensor for: receiving the raw depth data from the depth sensor; generating a mask image and generating a destination image; comparing the value of each pixel in the depth data and eroding a number of pixels around that compared pixel by assigning a one-value in the corresponding mask image pixels and assigning a zero-value in the corresponding destination image pixels; copying values of pixels in the raw depth data for which the corresponding mask image pixel has a value of zero to the destination image; outputting the destination image as the eroded depth data; and identifying, in the eroded depth data, the locations of first fiducial points and second fiducial points of the scanned subject.

Other aspects and features of the present disclosure will become apparent to those ordinarily skilled in the art upon review of the following description of specific embodiments in conjunction with the accompanying figures.

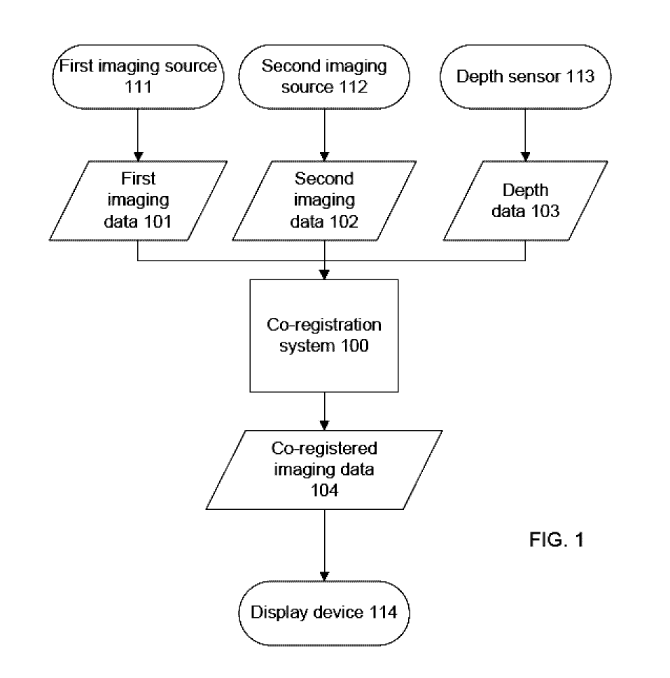

FIG. 1 shows a generalized block diagram of a medical imaging system according to an embodiment of the present disclosure. The imaging system comprises a co-registration system 100 that receives: first imaging data 101 from a first imaging source 111 in a first coordinate system; second imaging data 102 from a second imaging source 112 in a second coordinate system; and depth data 103 from a depth sensor 113. The system 100 processes the first imaging data 101, the second imaging data 102, and the depth data 103 to generate co-registered imaging data 104, which is displayed on a display device 114.

The first imaging data 101 may be information showing bodily functions, such as blood flow, electrical signals, etc. Thus, the first imaging data 101 may be any one of magnetoencephalography (MEG) data, transcranial magnetic stimulation (TMS) data, functional magnetic resonance imaging (fMRI) data, positron emission tomography (PET) data and diffusion tensor imaging (DTI) data, for example. The first imaging source 111 typically captures the first imaging data 101 as a collection of data values in a structured three-dimensional space. The structured three-dimensional space acts as a frame of reference for the data and is typically an arbitrary coordinate system specific to the first imaging source 111. Because the first imaging data 101 shows bodily function information within an arbitrary frame of reference, the first imaging data 101 alone is of limited use. It would be advantageous to combine the first imaging data 101 with information showing body structure.

The second imaging data 102 may be information showing body structure, such as bones, muscles, liquids, and other tissues. The second imaging data 102 may be one of MRI data and CT scan data, for example. The second imaging source 112 also typically captures the second imaging data 102 as a collection of data values in a structured three-dimensional space. However, the frame of reference for the second imaging data 101 is typically an arbitrary coordinate system specific to the second imaging source 112.

While it would be beneficial to combine the functional first imaging data 101 with the structural second imaging data 102, the combination is difficult because the frames of reference for both the first imaging data 101 and the second imaging data 102 are specific to each of the respective imaging sources 111 and 112. Co-registering the first imaging data 101 with the second imaging data 102 would require additional information to link the reference frames of the first coordinate system and the second coordinate system.

The co-registration system 100 uses the depth data 103 to link the first coordinate system with the second coordinate system. The depth data 103 includes information that is related to both the first and the second coordinate systems. By linking the first and second coordinate systems according to the embodiments below, the co-registration system 100 can co-register the first imaging data 101 with the second imaging data 102.

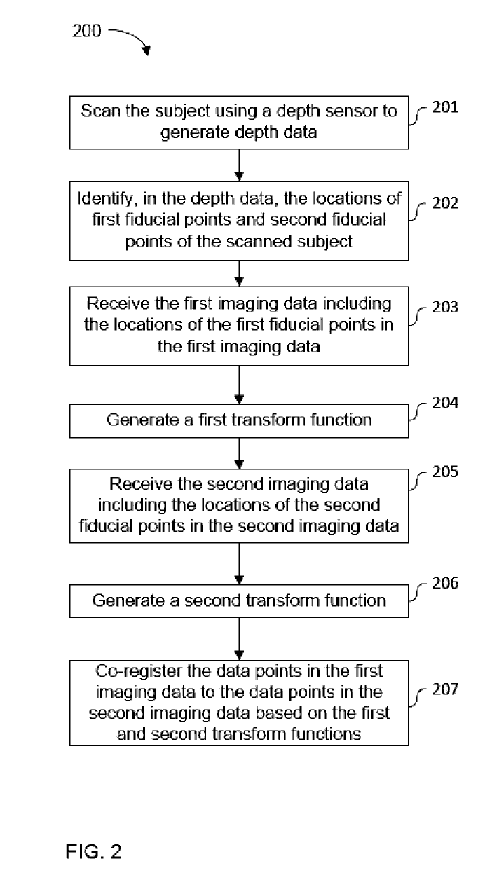

FIG. 2 shows a flowchart diagram of a co-registration method performed by the system 100, according to an embodiment of the present disclosure. The method 200 comprises, at 201, scanning the subject using a depth sensor 113 to generate depth data 103.

Next, at 202, the system identifies, in the depth data 103, the locations of first fiducial points and second fiducial points of the scanned subject. The first fiducial points are data points that can be associated with a first coordinate system and a third coordinate system. The first coordinate system is a frame of reference related to the first imaging data 101 and the third coordinate system is a frame of reference related to the depth data 103. The first fiducial points are associated with both the first and the third coordinate systems because the first fiducial points' locations can be identified in both the first imaging data 101 and the depth data 103. An example of the first fiducial point is an HPI coil, which can be imaged by both an MEG and by a depth sensor.

The second fiducial points are data points that can be associated with a second coordinate system and the third coordinate system. The second coordinate system is a frame of reference related to the second imaging data 102. The second fiducial points are associated with both the second and the third coordinate systems because the second fiducial points' locations can be identified in both the second imaging data 102 and the depth data 103. An example of the second fiducial point is an anatomical landmark, such as the location of the eyes, the nose, or other facial features on a head, which can be imaged by both an MRI and by a depth sensor. Other exemplary anatomical landmarks include the nasion, the pre-auricular, the peri-auricular, and the eyebrow ridge of a head.

At 203, the system receives the first imaging data 101, including the locations of the first fiducial points in the first imaging data 101.

At 204, the system generates a first transform function based on the locations of the first fiducial points in the depth data 103 and the first imaging data 101. Since the locations of the first fiducial points are captured by both of the first imaging data 101 and the depth data 103, these locations define a common frame of reference between the first imaging data 101 and the depth data 103. The first transform function has the purpose of mapping data points in the first coordinate system to data points in the third coordinate system.

At 205, the system receives the second imaging data 102. The second imaging data 102 is related to the second coordinate system, which is specific to the second imaging source 112. The second imaging data 102 also includes the second fiducial points of the subject. The locations of these second fiducial points in the second imaging data 102 are identified by the system.

At 206, the system generates a second transform function based on the locations of the second fiducial points in the second imaging data 102 and the depth data 103. Since the locations of the second fiducial points are captured by both of the second imaging data 102 and the depth data 103, these locations define a common frame of reference between the second imaging data 102 and the depth data 103. The second transform function has the purpose of mapping data points in the second coordinate system to data points in the third coordinate system.

At 207, the system co-registers the data points in the first imaging data 101 to the data points in the second imaging data 102 based on the first and second transform functions. In an embodiment, co-registering comprises mapping data points in the first imaging data 101 to corresponding data points in the second imaging data 102, via the first and second transform functions.

According to the method 200, the system can combine two different types of imaging data, in an overlaid fashion for example, in order to display more informative data visualizations to a user.

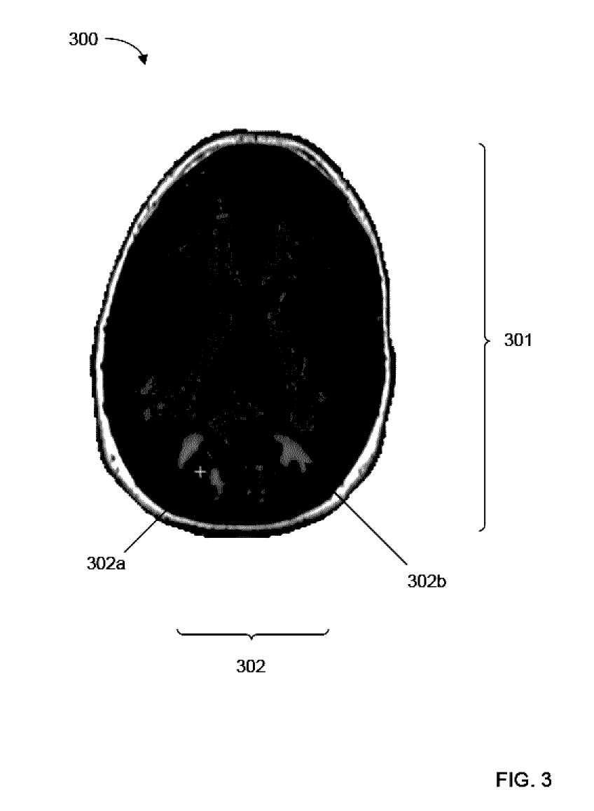

FIG. 3 is an example of a data visualization made from two overlaid imaging datasets. Image 300 shows overlaid data from magnetic resonance imaging (MRI) and magnetoencephalography (MEG) imaging sources as a result of a co-registration method according to an embodiment of the present disclosure.

MRI imaging can capture three-dimensional data that can be used to display tomographic images (slices) of a body in order to facilitate visualization of internal three-dimensional structures of the body.

MEG imaging can capture and map brain function activity. It is useful in helping a user understand brain processes and locate brain regions affected by illness. MEG data captures probable locations of brain activity based on weak magnetic fields generated by neural electric currents; therefore, MEG data alone, without a reference location, does not allow for accurate identification of locations in the brain displaying brain activity.

Consequently, it is more useful to combine MRI and MEG imaging data so that the functional brain activity can be identified and located with reference to brain structures. Co-registering and superimposing MRI and MEG imaging data can be referred to as creating magnetic source images.

Image 300 is a single tomographic image from a magnetic source image dataset. Image 300 includes a structural MRI 301 depiction of a two-dimensional slice of the brain. Image 300 also includes a functional MEG 302 depiction of brain activity at two locations 302a, 302b, in the brain. By co-registering and superimposing the MRI and MEG images, the structures of the brain exhibiting activity may be more accurately identified.

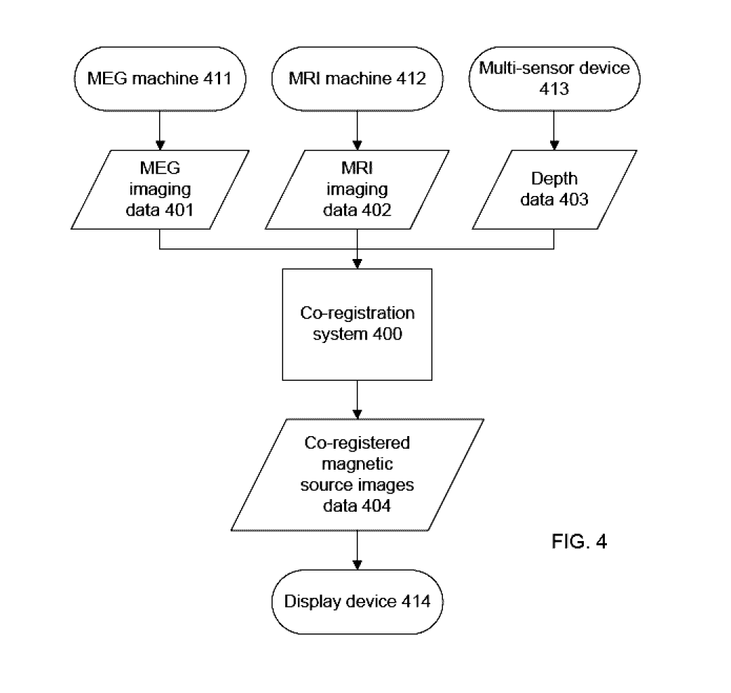

FIG. 4 shows a block diagram of an MRI-MEG imaging system according to an embodiment of the present disclosure. The MRI-MEG imaging system comprises a co-registration system 400 that receives: MEG imaging data 401 from an MEG machine 411 in an MEG coordinate system; MRI imaging data 402 from an MRI machine 412 in an MRI coordinate system; and depth data 403 from a multi-sensor device 413. The system 400 processes the MEG imaging data 401, the MRI imaging data 402, and the depth data 403 to generate co-registered magnetic source images data 404, which is displayed on a display device 414.

The multi-sensor device 413 used in the system for generating image 300 is a Microsoft Kinect® device. The Kinect® device includes an RGB (color) camera, an infrared (IR) projector, and an IR camera. The cameras have a resolution of 640×480 pixels and capture data at 30 frames per second. The IR projector emits a speckle pattern onto the environment and the IR camera captures this speckle pattern reflected off the environment. The Kinect® device calculates the depth image pixel values based on structured light and it combines two computer vision techniques: depth from focus and depth from stereo. While the Kinect® device is used in an embodiment of the present disclosure, it will be known that the multi-sensor device may be any combination of sensors capable of capturing and outputting depth data at a sufficiently high resolution.

A multi-sensor device 413 comprising the RGB camera, IR projector, and IR camera has many advantages over other types of devices for capturing depth data. The multi-sensor device can capture both color and depth data simultaneously at a frame rate of up to 30 fps. The relatively high frame rate allows for some subject movement without impairing co-registration accuracy. The co-registration accuracy is also improved by the relatively high point density of the multi-sensor device.

The co-registration system 400 uses the depth data 403 to link the MEG coordinate system with the MRI coordinate system. The depth data 403 includes information that is related to both the MEG and the MRI coordinate systems. By linking the MEG and MRI coordinate systems according to the embodiments below, the co-registration system 400 can co-register the MEG imaging data 401 with the MRI imaging data 402.

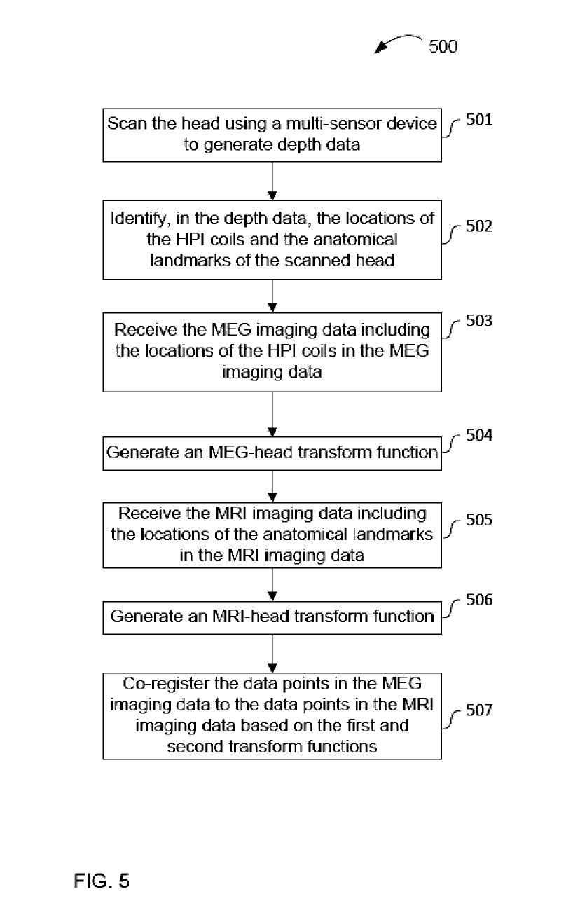

FIG. 5 shows a flowchart diagram of a method of co-registering data from MRI and MEG imaging sources, as performed by the system 400, according to a preferred embodiment of the present disclosure. The method 500 comprises, at 501, scanning a subject's head using the multi-sensor device 413 to generate depth data 403.

Next, at 502, the system identifies, in the depth data 403, the locations of HPI coils on the head and anatomical landmarks of the scanned head. The HPI coils are data points that can be associated with a MEG coordinate system of the MEG machine 411 and a head coordinate system of the multi-sensor device 413. The MEG coordinate system is a frame of reference related to the MEG imaging data 401 and the head coordinate system is a frame of reference related to the depth data 403. The HPI coils are associated with both the MEG and the head coordinate systems because the HPI coils' locations can be identified in both the MEG imaging data 401 and the depth data 403.

The anatomical landmarks are data points that can be associated with a MRI coordinate system of the MRI machine 412 and the head coordinate system. The MRI coordinate system is a frame of reference related to the MRI imaging data 402. The anatomical landmarks are associated with both the MRI and the head coordinate systems because the anatomical landmarks' locations can be identified in both the MRI imaging data 402 and the depth data 403. An example of an anatomical landmark is the location of the eyes, the nose, or other facial features on a head, which can be imaged by both an MRI and by a depth sensor. Other exemplary anatomical landmarks include the nasion, the pre-auricular, the peri-auricular, and the eyebrow ridge of a head.

At 503, the system receives the MEG imaging data 401, including the locations of the HPI coils in the MEG imaging data 401.

At 504, the system generates an MEG-head transform function based on the locations of the HPI coils in the depth data 403 and the MEG imaging data 401. Since the locations of the HPI coils are captured by both of the MEG imaging data 401 and the depth data 403, these locations define a common frame of reference between the MEG imaging data 401 and the depth data 403.

The MEG-head transform function has the purpose of mapping data points in the MEG coordinate system to data points in the head coordinate system.

At 505, the system receives the MRI imaging data 402. The MRI imaging data 402 is related to the MRI coordinate system, which is specific to the MRI machine 412. The MRI imaging data 402 also includes anatomical landmarks of the head. The locations of these anatomical landmarks in the MRI imaging data 402 are identified by the system. The MRI imaging data 402 is a dataset that represents a three-dimensional volume of the head, which, by definition, includes a representation of the facial surface of the head.

The depth data 403 may be a scan of the face, capturing the surface-level facial features. In this case, the depth data 403 and the MRI imaging data 402 will share common anatomical landmarks. At 506, the system generates an MRI-head transform function based on the locations of the anatomical landmarks in the MRI imaging data 402 and in the depth data 403. Since the locations of the anatomical landmarks are captured by both of the MRI imaging data 402 and the depth data 403, these locations define a common frame of reference between the MRI imaging data 402 and the depth data 403. The MRI-head transform function has the purpose of mapping data points in the second coordinate system to data points in the third coordinate system.

In a further embodiment, the system generates the MRI-head transform using an iterative closest point algorithm to align the depth data 403 to the MRI imaging data 402.

At 507, the system co-registers the data points in the MEG imaging data 401 to the data points in the MRI imaging data 402 based on the MEG-head and MRI-head transform functions. In an embodiment, co-registering comprises mapping data points in the MEG imaging data 401 to corresponding data points in the MRI imaging data 402, via the MEG-head and MRI-head transform functions.

According to the method 500, the system can combine and superimpose MEG and MRI imaging data in order to provide the user with more informative data visualizations such as image 300, for example.

The multi-sensor device 413 captures and outputs raw depth data by scanning the head. In a further embodiment, the depth data generated at 502 also comprises eroded depth data. The system generates eroded depth data by scanning and processing raw depth data from the multi-sensor device 413. Eroded depth data is used to reduce edge color smearing in the depth data generated from the multi-sensor device 413.

A multi-sensor device 413, such as the Kinect™ device captures color image data and depth image data from separate sensors on the device. The background colors in the image near the edge of a foreground object (i.e., edges in the depth image) can be mapped onto the edge of the foreground object. As a result, some color smearing may occur in the final 3-D dataset, wherein objects closer to the multi-sensor device pick up color from the background. Processing the raw depth data using an erosion function helps to reduce color smearing.

Generally, the erosion function processes a depth image by generating a mask image in which each pixel that is part of a close object (e.g., from 400 to 3000 mm from the camera plane) is set to a binary 1-value, and background pixels are set to a binary 0-value. Next, the erosion function erodes the boundary between the close object and the background in the mask image. For example, the erosion function may iteratively move along the boundary in the mask and change every pixel within a 15×15 pixel square to a binary 0-value. The eroded mask is then applied to the depth and color images to reduce the effects of edge color smearing on close objects in the color image.

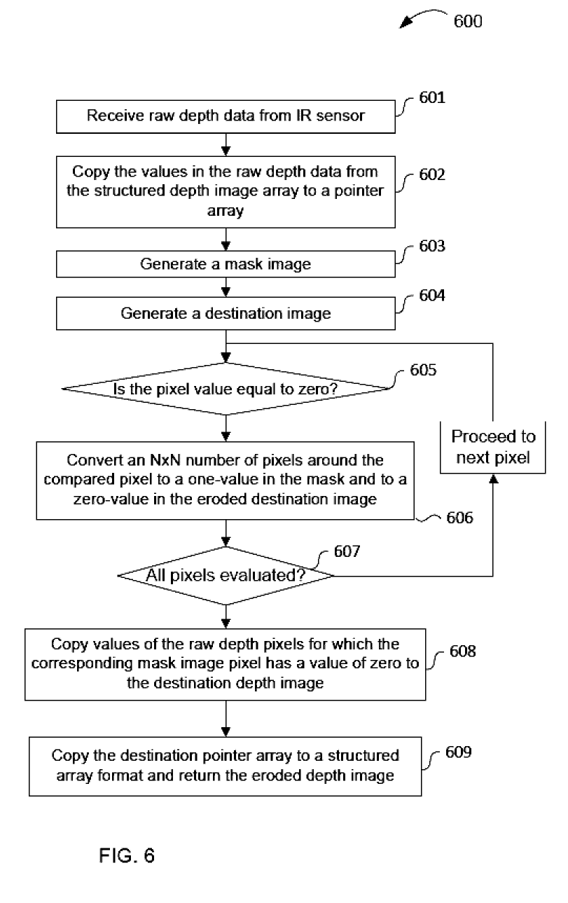

FIG. 6 is a flowchart diagram of a method of generating eroded depth data from raw depth data, according to an embodiment of the present disclosure.

At 601, the system receives raw depth data from the multi-sensor device. At 602, the system copies the values in the raw depth data from the structured depth image array to a pointer array.

At 603, the system generates a mask image with the same pixel size as the depth image. In the mask image, each pixel value is initialized to zero.

At 604, the system generates a destination image with the same pixel size as the depth image. In the destination image, each pixel value is also initialized to zero.

At 605, the system evaluates the depth image and its corresponding mask image. The value of each pixel in the depth image is compared to a depth value of zero. If the pixel value is equal to zero, then, at 606, an N×N number of pixels around that compared pixel are converted to a one-value in the mask and to a zero-value in the eroded destination image. This comparison is repeated until all of the pixels in the input depth image are evaluated. In an embodiment, the N×N number of pixels is 15×15.

At 607, the system determines whether all pixels in the raw depth image have been evaluated. If not, the system proceeds to evaluate the next pixel and returns to step 605. Thus, after operations 605 and 606 on all pixels in the depth image, the raw depth image is unchanged and the mask image has 1-values assigned to background pixels and 0-values assigned to object pixels. Furthermore, depending on the erosion function size (e.g., N×N, 15×15, etc.) a number of object pixels near the edge boundary of the object are assigned to a 1-value. In other words, the edge boundary of the object in the mask image has been slightly eroded. In the destination image, the background remains unchanged (the background pixels are assigned a 0-value) whilst a number of object pixels in the destination image near the edge boundary of the object are also assigned to a 0-value. In other words, the edge boundary of the object in the destination image has been slightly eroded.

If all of the pixels in the raw depth image have been evaluated, the system proceeds to 608 and the values of the raw depth pixels for which the corresponding mask image pixel has a value of zero are copied to the destination depth image. Therefore, in the destination image, the majority of the object pixels are unchanged (the object pixels are equal to the raw depth image pixel value), except for those edge boundary pixels that have been eroded.

At 609, the destination pointer array is then copied to a structured array format and returns the eroded depth image for the system to use in generating the MRI-head and MEG-head transform functions. According to method 600, the color data can be combined with the eroded depth data, rather than the raw depth data. When the color data is combined with the eroded depth data, the depth data 403 generated at 502 has reduced edge color smearing.

In an embodiment, the system executes method 600 in real-time during the IR scanning process. Therefore, the method 600 processes a depth image as quickly as the multi-sensor device captures raw depth data. For a multi-sensor device capturing depth data at 30 frames per second, the method 600 will execute 30 times per second and process 30 raw depth data images. In other words, the method 600 will complete in 1/30th of a second when processing raw depth data from a multi-sensor device capturing at 30 frames per second.

Being able to process raw depth images in real-time at 30 frames per second (and consequently being able to capture and generate depth data 403 in real-time) provides many advantages to the embodiments of the present disclosure. The real-time capture and generation allows for some subject movement without impairing co-registration accuracy.

The real-time capture and generation of depth data also allows for the multi-sensor device to be rotated about the head during scanning. In this embodiment, rotating the multi-sensor device around the heading during scanning improves the point density of the generated depth data because multiple scans of same head subject from multiple angles are combined into one 3D dataset. Since the capture and generation is performed in real-time, the step of rotating multi-sensor device is simplified in comparison to other systems.

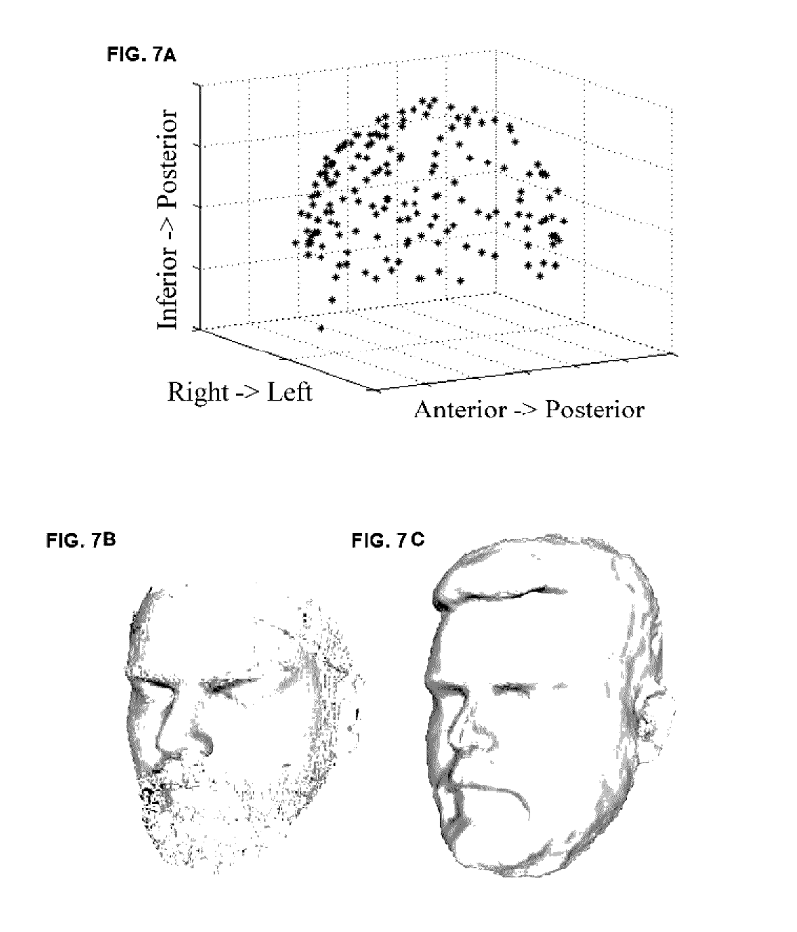

The relatively high point density of the multi-sensor device also improves the co-registration accuracy of the system. FIGS. 7A-7C show views of a data points in depth data of varying point densities generated from various devices. FIG. 7A is a perspective view of a data points in depth data generated from a Polhemus™ digitization device. FIG. 7B is a perspective view of data points in depth data generated from a laser scanning device. FIG. 7C is a perspective view of data points in depth data generated from a system according to an embodiment of the present disclosure. In the capture system of FIG. 7C, a Kinect device is rotated about a head during the scanning to generate the depth data. The increased point density in the depth data of FIG. 7C over the depth data of FIGS. 7A and 7B improves the co-registration accuracy of the co-registration system of FIG. 7C.

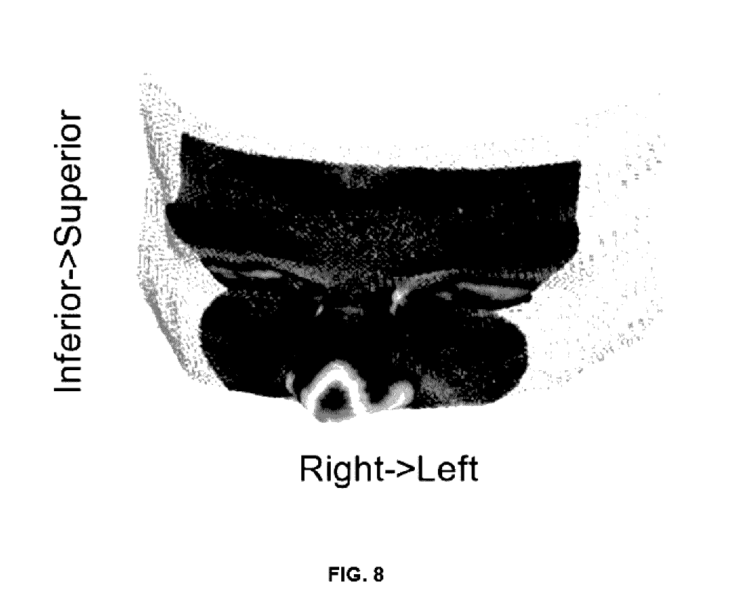

The improved co-registration accuracy imparted by higher point density depth data benefits the depth data capture and generation as well. FIG. 8 shows a perspective view of a raccoon mask according to an embodiment of the present disclosure. The term “raccoon mask” as used herein refers to a reduced area of head limited to a band around the eyes, brow ridge, and nose. Increased point density of depth data means that fewer anatomical landmarks are required for sufficient co-registration accuracy. Therefore, in the example of FIG. 8, the raccoon mask comprises sufficient depth data as it includes the eyes, brow ridge, nasion, and nose captured at high point density. These anatomical landmarks at high point density are sufficient for accurate co-registration of MEG and MRI data according to embodiments of the present disclosure.

While the present disclosure describes specific applications for various embodiments, including co-registering MRI and MEG imaging data, the method and system described herein may be applied to other imaging technologies. For example, the present disclosure is applicable to co-registering functional electroencephalography (EEG) data or transcranial magnetic stimulation (TMS) data with structural MRI data. The present disclosure is also applicable to co-registering imaging data with a patient's head and surgical tools during surgery.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A method for co-registering imaging data, the method comprising:
scanning a subject using a depth sensor to generate depth data;
identifying, in the depth data, the locations of first fiducial points and second fiducial points of the scanned subject;
receiving first imaging data including the locations of the first fiducial points;
generating a first transform function for mapping data in a coordinate system of the first imaging data to data in a coordinate system of the depth data, the first transform function based on the locations of the first fiducial points in both the depth data and the first imaging data;
receiving second imaging data including the locations of the second fiducial points;
generating a second transform function for mapping data in a coordinate system of the second imaging data to data in the coordinate system of the depth data, the second transform function based on the locations of the second fiducial points in both the depth data and the second imaging data; and
mapping the data points in the first imaging data to the data points in the second imaging data based on the first and second transform functions.

2. The method of claim 1, wherein the depth sensor is a multi-sensor device.

3. The method of claim 2, wherein the multi-sensor device comprises a color camera, an infrared projector, and an infrared camera.

4. The method of claim 3, wherein generating depth data comprises generating eroded depth data from raw depth data.

5. The method of claim 4, wherein generating eroded depth data comprises:
receiving raw depth data from the depth sensor;
generating a mask image and generating a destination image;
comparing the value of each pixel in the depth data and eroding a number of pixels around that compared pixel by assigning a one-value in the corresponding mask image pixels and assigning a zero-value in the corresponding destination image pixels;
copying values of pixels in the raw depth data for which the corresponding mask image pixel has a value of zero to the destination image; and
outputting the destination image as the eroded depth data.

6. The method of claim 5, further comprising:
copying values in the raw depth data from a structured depth image array to a pointer array in the destination image; and
outputting the eroded depth data by copying the destination pointer array in the destination image to a structured array format.

7. The method of claim 6, wherein scanning the subject using a multi-sensor device and generating the depth data is performed in real-time at 30 frames per second.

8. The method of claim 7, wherein scanning the subject comprises rotating the multi-sensor device around the subject during the scanning.

9. The method of claim 8, wherein the scanned subject is a head and the generated depth data is a raccoon mask.

10. The method of claim 1, wherein the first imaging data is MEG imaging data and the first fiducial points are HPI coils.

11. The method of claim 1, wherein the second imaging data is MRI imaging data and the second fiducial points are anatomical landmarks.

12. The method of claim 11, wherein the anatomical landmarks include at least one of the eyes, the nose, the brow ridge, the nasion, the pre-auricular, and the peri-auricular of a head.

13. A system for co-registering imaging data, the system comprising:
a depth sensor for scanning a subject and generating depth data; and
a processor connected to the depth sensor for:
identifying, in the depth data, the locations of first fiducial points and second fiducial points of the scanned subject;
receiving first imaging data including the locations of the first fiducial points;
generating a first transform function for mapping data in a coordinate system of the first imaging data to data in a coordinate system of the depth data, the first transform function based on the locations of the first fiducial points in both the depth data and the first imaging data;
receiving second imaging data including the locations of the second fiducial points;
generating a second transform function for mapping data in a coordinate system of the second imaging data to data in the coordinate system of the depth data, the second transform function based on the locations of the second fiducial points in both the depth data and the second imaging data; and
mapping the data points in the first imaging data to the data points in the second imaging data based on the first and second transform functions.

14. The system of claim 13, wherein the depth sensor is a multi-sensor device.

15. The system of claim 14, wherein the multi-sensor device comprises a color camera, an infrared projector, and an infrared camera.

16. The system of claim 15, wherein the processor generates eroded depth data from raw depth data generated from the multi-sensor device.

17. The system of claim 16, wherein the processor is configured to generate eroded depth data by:
receiving raw depth data from the depth sensor;
generating a mask image and generating a destination image;
comparing the value of each pixel in the depth data and eroding a number of pixels around that compared pixel by assigning a one-value in the corresponding mask image pixels and assigning a zero-value in the corresponding destination image pixels;
copying values of pixels in the raw depth data for which the corresponding mask image pixel has a value of zero to the destination image; and
outputting the destination image as the eroded depth data.

18. The system of claim 17, wherein the processor is further configured to generate eroded depth data by:
copying values in the raw depth data from a structured depth image array to a pointer array in the destination image; and
outputting the eroded depth data by copying the destination pointer array in the destination image to a structured array format.

19. The system of claim 18, wherein the multi-sensor device scans the subject at 30 frames per second and the processor generates the eroded depth data in real-time at 30 frames per second.

20. The system of claim 19, wherein the multi-sensor device is rotated around the subject during the scanning.

21. The system of claim 20, wherein the scanned subject is a head and the generated depth data is a raccoon mask.

22. The system of claim 13, wherein the first imaging data is MEG imaging data and the first fiducial points are HPI coils.

23. The system of claim 13, wherein the second imaging data is MRI imaging data and the second fiducial points are anatomical landmarks.

24. The system of claim 23, wherein the anatomical landmarks include at least one of the eyes, the nose, the brow ridge, the nasion, the pre-auricular, and the peri-auricular of a head.

25. A method for generating depth data used to co-register imaging data, the method comprising:
scanning a subject using a depth sensor to generate raw depth data;
generating a mask image and generating a destination image;
comparing the value of each pixel in the depth data and eroding a number of pixels around that compared pixel by assigning a one-value in the corresponding mask image pixels and assigning a zero-value in the corresponding destination image pixels;
copying values of pixels in the raw depth data for which the corresponding mask image pixel has a value of zero to the destination image;
outputting the destination image as the eroded depth data; and
identifying, in the eroded depth data, the locations of first fiducial points and second fiducial points of the scanned subject.

26. A system for generating depth data used to co-register imaging data, the system comprising:
a depth sensor for scanning a subject and generating raw depth data; and
a processor connected to the depth sensor for:
receiving the raw depth data from the depth sensor;
generating a mask image and generating a destination image;
comparing the value of each pixel in the depth data and eroding a number of pixels around that compared pixel by assigning a one-value in the corresponding mask image pixels and assigning a zero-value in the corresponding destination image pixels;
copying values of pixels in the raw depth data for which the corresponding mask image pixel has a value of zero to the destination image;
outputting the destination image as the eroded depth data; and
identifying, in the eroded depth data, the locations of first fiducial points and second fiducial points of the scanned subject.
